(19) United States
(12) Patent Application Publication
(10) Pub. No.: US 2009/0135376 A1
(43) Pub. Date: May 28, 2009

(54) LIGHTING APPARATUS, DISPLAY APPARATUS, PROJECTION DISPLAY APPARATUS, LIGHTING METHOD, IMAGE DISPLAY METHOD AND IMAGE PROJECTION METHOD

(76) Inventors: Tatsuo Itoh, Osaka (JP); Kazuhisa Yamamoto, Osaka (JP); Kenichi Kasazumi, Osaka (JP); Tetsuro Mizushima, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/064,926

(22) PCT Filed: Aug. 2, 2006
(86) PCT No.: PCT/JP2006/315270

§ 371 Date: Feb. 26, 2008

(30) Foreign Application Priority Data
Aug. 26, 2005 (JP) 2005-245604

(51) Int. Cl. G03B 21/00; F21V 9/00

(52) U.S. Cl. 353/31; 362/231

(57) ABSTRACT

Red light emitted from a red laser light source, green light emitted from a green laser light source and blue light emitted from a blue laser light source are incident on a first disc body of a color wheel, are transmitted or reflected in conformity with the colors of the lights in wavelength selecting regions of a second disc body every time the color wheel performs a predetermined rotation. AS being reflected by the first disc body, the lights are divided into different positions to be emitted from the color wheel and irradiated to irradiation regions successively switched by an upward or downward reciprocal movement of a mirror group.

### TECHNOLOGICAL FIELD

The present invention relates to lighting apparatus and method for lighting color image display elements, a display apparatus and a projection display apparatus including the lighting apparatus, and an image display method and an image projection method using the lighting method.

### BACKGROUND ART

Liquid crystal display apparatuses using large-size liquid crystal panels and projection or rear-projection display apparatuses using transmissive/reflective liquid crystal elements or spatial light modulation elements such as micromirror devices are known as large screen display apparatuses. For the formation of a color image, there are a type of projection and rear-projection display apparatuses including three spatial light modulation elements in correspondence with three primary colors of red, green and blue and another type thereof for synthesizing a color image by irradiating one spatial light modulation element with lights of three primary colors in a time shared manner.

As a method for irradiating lights of three primary colors in a time shared manner, there is a method for dividing a light from a white light source into lights of three primary colors by a color wheel formed with filters of three primary colors and successively irradiating the lights of three primary colors by the rotation of the color wheel. This method has had a problem that light utilization efficiency for transmission through the filters is reduced to one third. In order to solve this problem, there has been proposed a method for successively moving color bands of three primary colors on a spatial light modulation element (see, for example, patent literature 1).

The method disclosed in patent literature 1 is described with reference to FIG. 14. FIG. 14 is a section showing the construction of a conventional projection display apparatus. In FIG. 14, identified by 101 is a lamp, by 102 an elliptical reflector and by 103 a cold mirror. Identified by 104 is a dichroic mirror group for dividing a white light emitted from the lamp 101 into lights of three primary colors of red, green and blue. Identified by 105 is a rotary prism rotatable about an axis perpendicular to the plane of FIG. 14. Identified by 106, 107 are relay lenses. Identified by 108 is a light valve, which is, for example, a liquid crystal panel. Identified by 109 is a projection lens. Identified by 110 is a rotation driving circuit for driving the rotary prism 105 and by 111 a color signal processing circuit for supplying red, green and blue color signals in accordance with regions of three primary color lights of the light valve 108.

In FIG. 14, a white light emitted from the lamp 101 is reflected by the cold mirror 103 to be incident on the dichroic mirror group 104. A white light emitted backward from the lamp 101 is reflected by the cold mirror 103 to be incident on the dichroic mirror group 104 after being reflected by the elliptical reflector 102. The dichroic mirror group 104 divides the white light into lights of three primary colors of red, green and blue in a vertical direction in the plane of FIG. 14 and causes the primary color lights to be incident on the rotary prism 105 as light beams having a rectangular cross section.

When the rotary prism 105 rotates, the light beams of three primary colors of red, green and blue successively move in the vertical direction, e.g. from up to down in the plane of FIG. 14 by a refracting action. The light beams emerging from the rotary prism 105 are incident on the light valve 108 by the relay lenses 106, 107. The light valve 108 is region-divided in the vertical direction of the plane of FIG. 14, color signals are set in accordance with the colors of the incident lights incident in the respective regions, and the respective regions move in synchronism with the movements of the light beams to display an image. The image on the light valve 108 is projected onto an unillustrated screen by the projection lens 109.

In the construction of patent literature 1, if the rotary prism 105 is rotated at a constant speed, the vertical moving speeds of the light beams cannot be constant. Therefore, measures need to be taken, for example, by forming the incidence and emergence surfaces of the rotary prism 105 into cylindrical shapes. Further, the light having passed through the bottommost part of the light valve 108 does not immediately move to the uppermost part of the light valve 108. Therefore, there has been a problem of causing a loss in the light utilization efficiency.

### Patent Literature 1: Publication of Japanese Patent No. 3352100

### DISCLOSURE OF THE INVENTION

In order to solve the above problems, an object of the present invention is to provide a lighting apparatus, the light utilization efficiency of which is improved by a simple optical system.

In order to accomplish the above object, the present invention is directed to a lighting apparatus, comprising N laser light sources, an optical path switching member and a lighting optical system. The N laser light sources emit lights in at least three different wavelength ranges. The optical path switching member divides the lights emitted from the N laser light sources into spatially different irradiation regions separated by separation regions for the respective wavelength ranges and successively switches to the different irradiation regions at specified time intervals. The lighting optical system irradiates the lights emitted from the optical path switching member.

According to this construction, by dividing the lights in the different wavelength ranges into the spatially different irradiation regions with the separation regions and successively switching to the different irradiation regions at the specified time intervals, the illumination lights can be immediately moved to the specified irradiation regions at the specified time intervals to be constantly present in the irradiation regions without requiring a complicated optical system for moving the illumination lights at a constant speed as in the prior art. Therefore, light utilization efficiency can be improved by a simple optical system.

### BRIEF DESCRIPTION OF THE DRAWINGS

FIG. 1 is a section showing a schematic construction of a projection display apparatus according to a first embodiment of the invention,

FIG. 2A is a plan view showing a structure of a first disc body constituting a color wheel shown in FIG. 1,

FIG. 2B is a plan view showing a structure of a second disc body constituting the color wheel shown in FIG. 1,

FIG. 3A is a diagram showing an image forming state on a spatial light modulation element in the case where a mirror group shown in FIG. 1 is moved to a specified position in an upward direction,

FIG. 3B is a diagram showing an image forming state on the spatial light modulation element in the case where the mirror group shown in FIG. 1 is moved to a specified position in a downward direction,

FIG. 4 is a diagram showing a state where lighted regions and separation regions are switched on the spatial light modulation element at specified time intervals,

FIG. 5 is a section showing a modification of a driving method for the mirror group in the first embodiment of the invention,

FIG. 6 is a section showing another modification of the driving method for the mirror group in the first embodiment of the invention,

FIG. 7 is a section showing still another modification of the driving method for the mirror group in the first embodiment of the invention,

FIG. 8 is a section showing a schematic construction of an optical path switching member in a projection display apparatus according to a second embodiment of the invention,

FIG. 9 is a section showing a schematic construction of an optical path switching member in a projection display apparatus according to a third embodiment of the invention,

FIG. 10A is a plan view showing a structure of a first disc body constituting a color wheel shown in FIG. 9,

FIG. 10B is a plan view showing a structure of a second disc body constituting the color wheel shown in FIG. 9,

FIG. 11 is a schematic construction diagram of a projection display apparatus according to a fourth embodiment of the invention,

FIG. 12 is a diagram showing a state where lighted regions on a spatial light modulation element are switched at specified time intervals in a projection display apparatus according to a fifth embodiment of the invention,

FIG. 13 is a diagram showing a schematic partial construction of an optical path switching member in a projection display apparatus according to a sixth embodiment of the invention, and

FIG. 14 is a section showing a schematic construction of a conventional projection display apparatus.

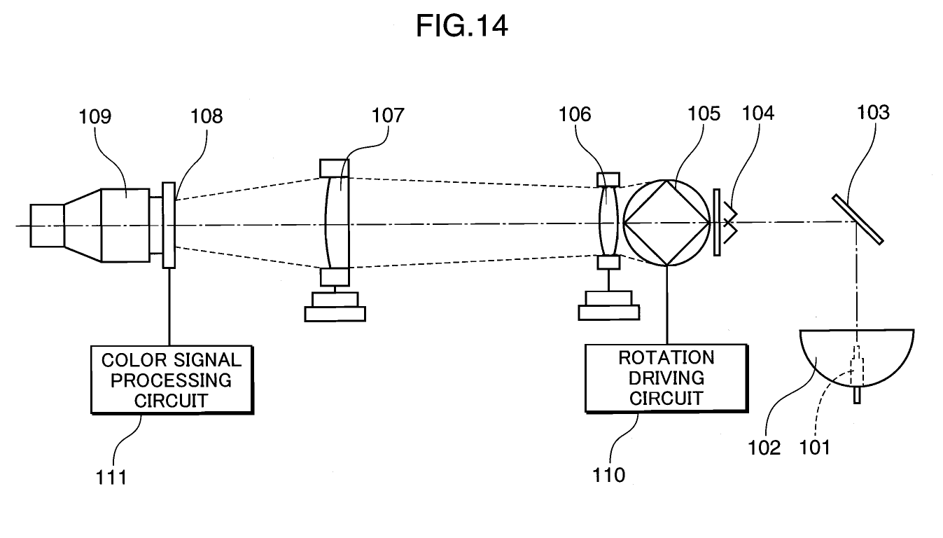

### BEST MODES FOR EMBODYING THE INVENTION

Hereinafter, embodiments of the present invention are described with reference to the accompanying drawings.

### First Embodiment

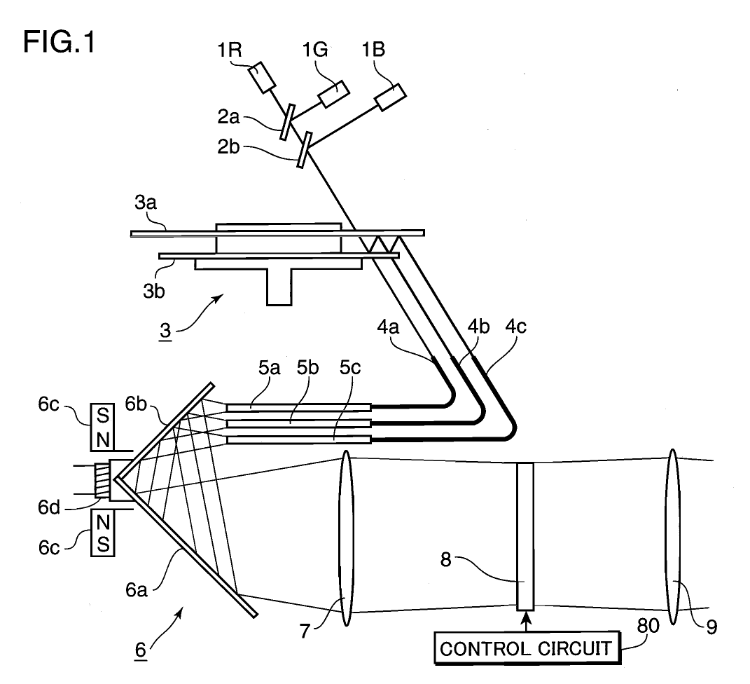

FIG. 1 is a section showing a schematic construction of a projection display apparatus according to a first embodiment of the invention. In FIG. 1, identified by 1R is a red laser light source for emitting red laser light, by 1G a green laser light source for emitting green laser light and by 1B a blue laser light source for emitting blue laser light.

Identified by 2a, 2b are dichroic mirrors, wherein the dichroic mirror 2a transmits red light while reflecting green light and the dichroic mirror 2b reflects blue light while transmitting red and green lights.

Identified by 3 is a color wheel made up of first and second disc bodies 3a, 3b and disposed on optical paths of the lights emitted from the light sources 1R, 1G and 1B.

Identified by 4a, 4b and 4c are light guides, each of which receives any one of the color lights having passed through the color wheel 3 at one end and emits it from the other end.

Identified by 5a, 5b and 5c are rod integrators, which are, for example, parallelepipedic prisms. Each rod integrator 5a, 5b or 5c produces a uniform light quantity distribution at the other end thereof by the multiple reflections of the light incident on one end thereof inside.

Identified by 6 is a mirror group comprised of a first mirror 6a and a second mirror 6b. The first and second mirrors 6a, 6b are integrally retained at right angles to each other by an unillustrated retainer. The mirror group 6 reciprocates between specified positions along a vertical direction relative to the rod integrators 5a, 5b and 5c by being attracted toward one of permanent magnets 6c while being repelled by the other permanent magnet 6c through the action of two permanent magnets 6c and an electromagnet 6d, i.e. through the switching of a direction of a current flowing into the electromagnet 6d.

Identified by 7 is a lighting optical system and by 8 a spatial light modulation element, which is preferably a transmissive liquid crystal element, a reflective liquid crystal element or a micromirror array. The lighting optical system 7 is arranged to image the emergent ends of the rod integrators 5a, 5b and 5c on the spatial light modulation element 8, and the rod integrators 5a, 5b and 5c are arranged such that the width of the emergent ends thereof is equal to the spacing between them and are set such that the image areas of the rod integrators 5a, 5b and 5c on the spatial light modulation element 8 are half the area of the spatial light modulation element 8.

Identified by 80 is a control circuit for serially transmitting image color signals corresponding to the respective colors to the spatial light modulation element 8 in correspondence with irradiation regions of the red, green and blue lights on the spatial light modulation element 8.

Identified by 9 is a projection lens for projecting the light modulated by the spatial light modulation element 8 onto an unillustrated screen.

In FIG. 1, red light emitted from the red laser light source 1R passes through the dichroic mirror 2a. Green light emitted from the green laser light source 1G is reflected by the dichroic mirror 2a and propagates along a common optical axis together with the red light emitted from the red laser light source 1R. Blue light emitted from the blue laser light source 1B is reflected by the dichroic mirror 2b and propagates along the common optical axis together with the red and green lights having passed through the dichroic mirror 2b to be incident on the color wheel 3.

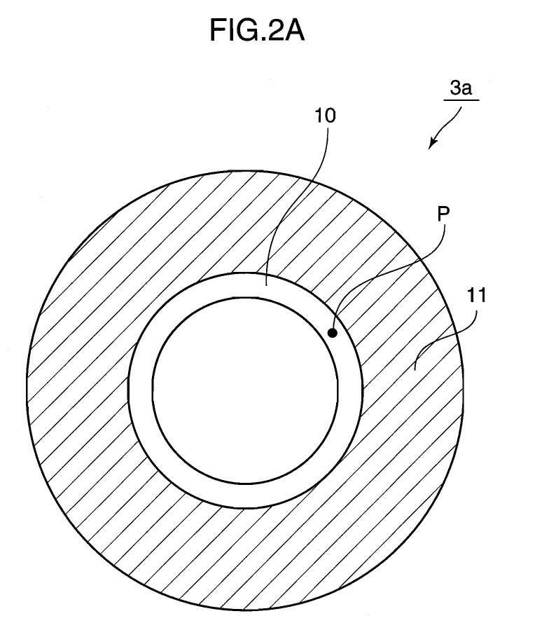

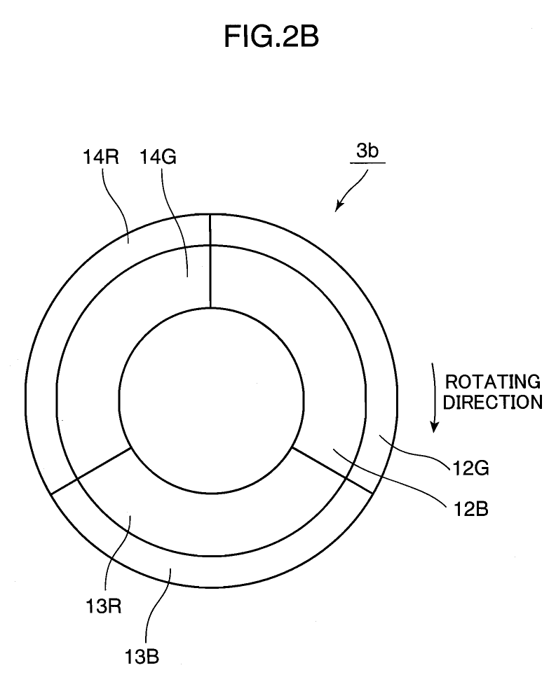

The light incident on the color wheel 3 is divided into the red, green and blue lights while being reflected between the first and second disc bodies 3a, 3b, and each of these lights is incident on one end of any one of the three light guides 4. The structure and function of the color wheel 3 are described below with reference to FIGS. 2A and 2B.

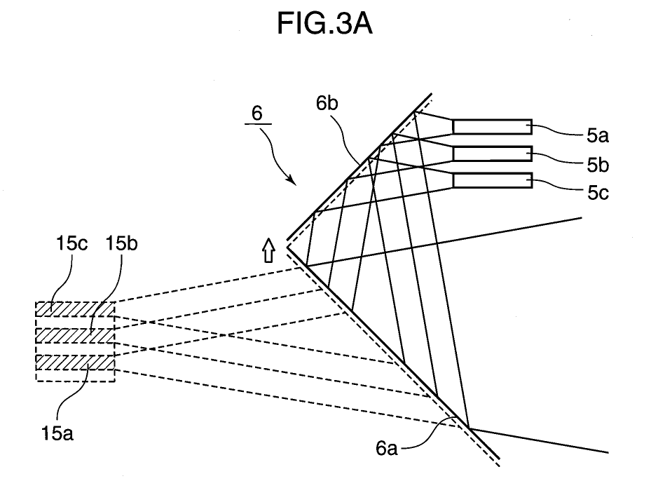

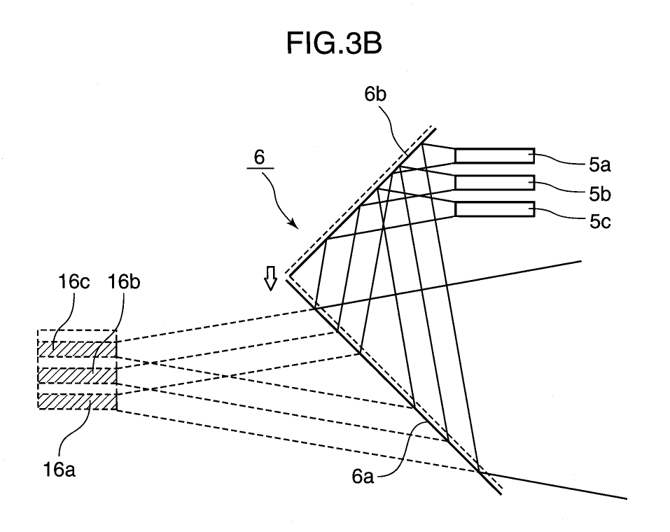

FIG. 2A is a plan view showing a structure of the first disc body 3a constituting the color wheel 3. In FIG. 3A, the first disc body 3a includes an inner circumferential region 10 for transmitting the light and an outer circumferential region 11 for reflecting the light. The respective color lights emitted from the red, green and blue laser light sources 1R, 1G and 1B enter the inside of the color wheel 3 by passing through the inner circumferential region 10.

FIG. 2B is a plan view showing a structure of the second disc body 3b constituting the color wheel 3. In FIG. 3B, the second disc body 3b is circumferentially divided into three and radially divided into two, whereby regions 12B, 12G adjacent in a radial direction, regions 14G, 14R adjacent in a radial direction and regions 13R, 13B adjacent in a radial direction are circumferentially formed. Dichroic mirrors are formed or adhered in the respective regions, which have the same area. The regions 12G, 14G transmit only green light while reflecting other red and blue lights. The regions 13R, 14R transmit only red light while reflecting other green and blue lights. The regions 12B, 13B transmit only blue light while reflecting other red and green lights.

In FIGS. 2A and 2B, if light obliquely incident on a point P of the inner circumferential region 10 of the first disc body 3a is incident on the region 12B of the second disc body 3b, only the blue light transmits while the green and red lights are reflected to propagate toward the outer circumferential region 11 of the first disc body 3a. The green and red lights are reflected again by the outer circumferential region 11 to be incident on the region 12G and only the green light transmits. The remaining red light is reflected again by the outer circumferential region 11 and emerges parallel to the other blue and green lights at the outer side of the second disc body 3b because the diameter of the second disc body 3b is smaller than that of the first disc body 3a.

Subsequently, when the color wheel 3 rotates in a direction of arrow in FIG. 2B, the light obliquely incident on the inner circumferential region 10 of the first disc body comes to be incident on the region 14G of the second disc body 3b, whereby only the green light transmits while the red and blue lights are reflected to propagate toward the outer circumferential region 11 of the first disc body 3a. The red and blue lights are reflected again by the outer circumferential region 11 to be incident on the region 14R, and only the red light transmits. The remaining blue light is reflected again by the outer circumferential region 11 and emerges parallel to the other green and red lights at the outer side of the second disc body 3b.

Subsequently, when the color wheel 3 rotates in the direction of arrow in FIG. 2B by a specified amount (⅓ rotation), the light obliquely incident on the inner circumferential region 10 of the first disc body comes to be incident on the region 13R of the second disc body 3b, whereby only the red light transmits while the green and blue lights are reflected to propagate toward the outer circumferential region 11 of the first disc body 3a. The green and blue lights are reflected again by the outer circumferential region 11 to be incident on the region 13B, and only the blue light transmits. The remaining green light is reflected again by the outer circumferential region 11 and emerges parallel to the other red and blue lights at the outer side of the second disc body 3b.

As described above, every time the color wheel 3 performs a ⅓ rotation, the red, green and blue lights emerge at different positions. Specifically, by the above operation example, the blue light is, at first, incident on one end of the light guide 4a and emerges from the other end thereof to be incident on one end of the rod integrator 5a; the green light is incident on one end of the light guide 4b and emerges from the other end thereof to be incident on one end of the rod integrator 5b; and the red light is incident on one end of the light guide 4c and emerges from the other end thereof to be incident on one end of the rod integrator 5c.

When the color wheel performs a ⅓ rotation, the green light is incident on the one end of the light guide 4a and emerges from the other end thereof to be incident on the one end of the rod integrator 5a; the red light is incident on the one end of the light guide 4b and emerges from the other end thereof to be incident on the one end of the rod integrator 5b; and the blue light is incident on the one end of the light guide 4c and emerges from the other end thereof to be incident on the one end of the rod integrator 5c.

When the color wheel further performs a ⅓ rotation, the red light is incident on the one end of the light guide 4a and emerges from the other end thereof to be incident on the one end of the rod integrator 5a; the blue light is incident on the one end of the light guide 4b and emerges from the other end thereof to be incident on the one end of the rod integrator 5b; and the green light is incident on the one end of the light guide 4c and emerges from the other end thereof to be incident on the one end of the rod integrator 5c.

The light incident on the one end of each rod integrator 5a, 5b or 5c as above emerges with a uniform light quantity distribution from the other end thereof through multiple reflections. The lights emitted from the rod integrators 5a, 5b and 5c are imaged on the spatial light modulation element 8 by the lighting optical system 7 after being reflected by the mirror group 6. At this time, if the mirror group 6 moves, the image on the spatial light modulation element 8 also moves. The function of the mirror group 6 is described with reference to FIGS. 3A and 3B.

FIG. 3A is a diagram showing an image forming state on the spatial light modulation element 8 in the case where the mirror group 6 moves to a specified position in an upward direction, and FIG. 3B is a diagram showing an image forming state on the spatial light modulation element 8 in the case where the mirror group 6 moves to a specified position in a downward direction. In FIGS. 3A and 3B, the same elements as in FIG. 1 are identified by the same reference numerals and are not described. Identified by 15a is a mirror image of the rod integrator 5a, by 15b a mirror image of the rod integrator 5b and by 15c a mirror image of the rod integrator 5c. In FIG. 3A, beams are shown by solid line and virtual images and beams emerging from the virtual images are shown by broken line. FIG. 3B shows a state when the mirror group 6 is moved only by a distance that is half the spacing between the rod integrators 5a, 5b and 5c, wherein mirror images of the rod integrators 5a, 5b and 5c are identified by 16a, 16b and 16c.

By moving the mirror group 6 only by the distance that is half the spacing between the rod integrators 5a, 5b and 5c, the mirror images 15a, 15b, 15c and 16a, 16b, 16c of the rod integrators 5a, 5b and 5c can be adjacent to each other. Since the mirror images 15a, 15b, 15c and 16a, 16b, 16c are imaged on the spatial light modulation element 8 by the lighting optical system 7, the images of the rod integrators 5a, 5b and 5c are alternately imaged on the spatial light modulation element 8 as the mirror group 6 is moved.

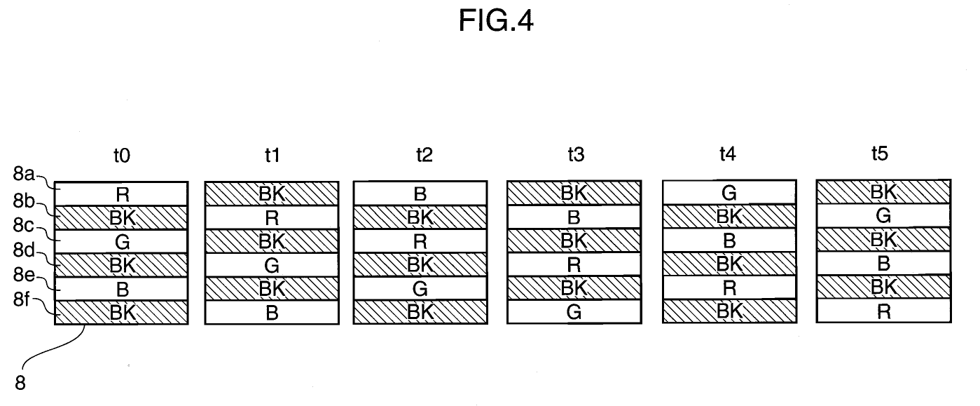

Next, with reference to FIG. 4, a state of switching irradiation regions and separation regions on the spatial light modulation element 8 at specified time intervals, i.e. by the ⅓ rotation of the color wheel 3 and the vertical movement of the mirror group 6.

In FIG. 4, identified by 8 is the spatial light modulation element, which is divided into six regions 8a to 8f in correspondence with the images of the rod integrators 5a, 5b and 5c. In FIG. 4, symbols R, G and B shown in the regions 8a to 8f indicate that the respective regions are irradiated with red, green and blue illumination lights. A symbol BK indicates that the region is not irradiated with light or the spatial light modulation element 8 is in an OFF state (state to block the light).

At time t0, the region 8a is illuminated with the red light, the region 8c with the green light and the region 8e with the blue light, whereas the regions 8b, 8d and 8f are not irradiated with light.

When the mirror group 6 moves to the specified position in the downward direction at time t1, the irradiation regions shift with the order of the red, green and blue lights maintained.

When the color wheel 3 performs a ⅓ rotation from time t1 to change the arrangement of the lights incident on the rod integrators 5a, 5b and 5c and the mirror group 6 moves to the specified position in the upward direction at time t2, the region 8a is illuminated with the blue light, the region 8c with the red light and the region 8e with the green light.

Thereafter, when the reciprocal movement of the mirror group 6 and the rotation of the color wheel 3 are repeated, the state at time t0 is returned via states at times t3, t4 and t5. If this one cycle is repeated, the spatial light modulation element 8 comes to have the entire surface thereof irradiated with the three primary color lights of red, green and blue, and a color image can be formed by inputting image color signals corresponding to the illumination lights to the regions 8a to 8f from the control circuit 80 in synchronism with the illumination lights. A color projected image can be formed by focusing the image of the spatial light modulation element 8 by means of the projection lens 9.

Here, the moving period of the mirror group 6 and the rotating speed of the color wheel 3 are specifically described. Since one field period of a television image signal is 1/60 sec., the rotating speed of the color wheel 3 is 60 rotations per second, i.e. 3600 rpm. Further, periods during which the lighted state is switched from time t0→time t1→time t2→time t3→time t4→time t5→time t0 shown in FIG. 4 is 1/(6×60)=2.77 msec. and a switching frequency is 360 Hz. The mirror group 6 needs to be moved upward or downward at each time, and it is thought to give substantially no influence on the projected image if the moving period of the mirror group 6 is, for example, about 1/10 of the switching period of 2.77 msec., i.e. about 0.3 msec. (period for about 5 lines). According to the driving method by a combination of the two permanent magnets 6c and the electromagnet 6d in this embodiment, the moving period of 0.3 msec. of the mirror group 6 can be sufficiently realized.

In FIG. 4, in the case of switching the lighted state from state at t0→state at t2→state at t4→state at t1→state at t3→state at time t5→state at time t0, the mirror group 6 needs to be moved only at the time of switching from the state at t4 to the state at t1 and from the state at t5 to the state at t0. Thus, the switching period is 2.77×3=8.31 msec. Thus, the moving period (0.3 msec.) of the mirror group 6 hardly affects the projected image.

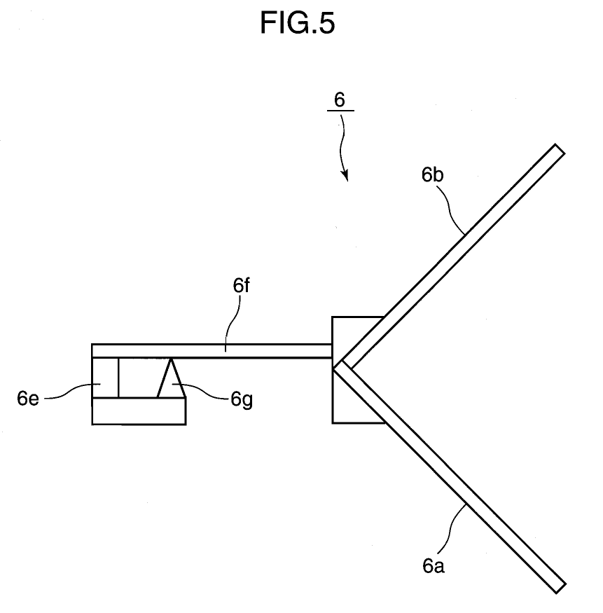

FIG. 5 is a section showing a modification of the driving method for the mirror group 6. In FIG. 5, the mirror group 6 is driven to reciprocate along the vertical direction between the specified positions by driving means including a piezoelectric actuator 6e for converting a voltage change into a mechanical change, a supporting column 6f having the piezoelectric actuator 6e arranged at a point of force and the mirrors 6a, 6b bonded at a point of action, and a fulcrum member 6g arranged at a fulcrum of the supporting column 6f for enlarging the mechanical change of the piezoelectric actuator 6e by the principle of leverage.

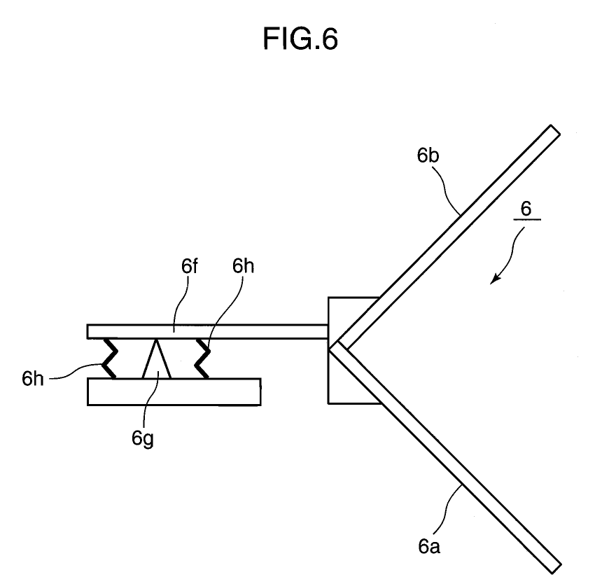

FIG. 6 is a section showing another modification of the driving method for the mirror group 6. In FIG. 6, the mirror group 6 is driven to reciprocate along the vertical direction between the specified positions using the principle of leverage as in FIG. 5 by the push/pull operations of two shape memory alloys 6h, i.e. by one shake memory alloy 6h contracting while the other is elongating, instead of the piezoelectric actuator 6e shown in FIG. 5.

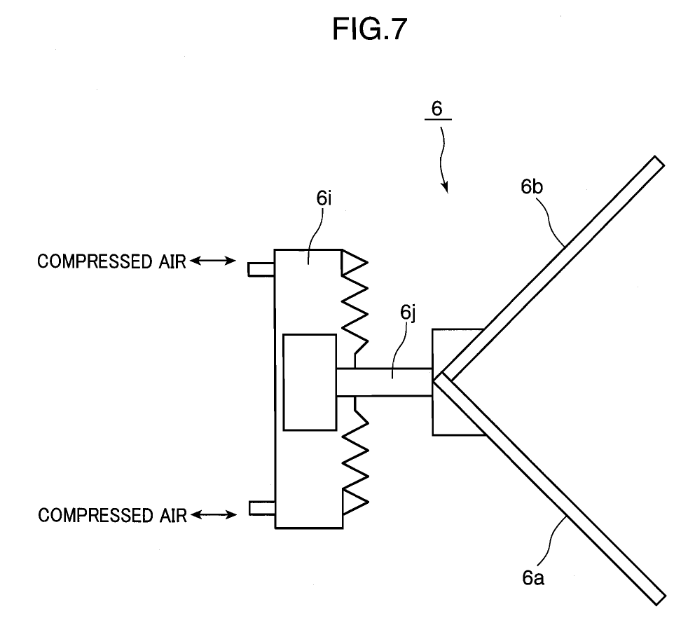

FIG. 7 is a section showing still another modification of the driving method for the mirror group 6. In FIG. 7, the mirror group 6 is driven to reciprocate along the vertical direction between the specified positions by driving means including a cylinder 6i having compressed air sucked from one opening and having the compressed air discharged from the other opening, and a cylinder 6j having one end bonded to the mirrors 6a, 6b and the other end slidable as the compressed air is sucked into and discharged from the cylinder 6i.

As described above, according to the first embodiment, the three primary color lights discretely illuminate the regions 8a to 8f of the spatial light modulation element 8. Thus, it is not necessary to consider the constant velocity property of the movements of the illumination lights described in the prior art. Further, light utilization efficiency is high since the illumination lights are constantly located in any of the regions 8a to 8f.

The images of the rod integrators 5a, 5b and 5c on the spatial light modulation element 8 need to be so positioned as to accurately overlap with the regions 8a to 8f. Positioning accuracy can be reduced by setting the dimensions of the images of the rod integrators 5a, 5b and 5c slightly larger than those of the regions 8a to 8f and providing the OFF regions in the spatial light modulation element 8.

For the distortions of the rod integrator images caused by the color aberration and distortion of the lighting optical system 7, there is an effect of being able to eliminate unnecessary parts by providing the OFF regions in the spatial light modulation element 8 and using them as openings. Further, there is no occurrence of mixing the illumination lights of the respective colors overlapping each other by providing the OFF regions in the spatial light modulation element 8.

The first embodiment is described, taking the projection display apparatus as an example. It is also possible to use a large-size liquid crystal panel as the spatial light modulation element 8 and to let it operate as a display apparatus by being directly seen.

### Second Embodiment

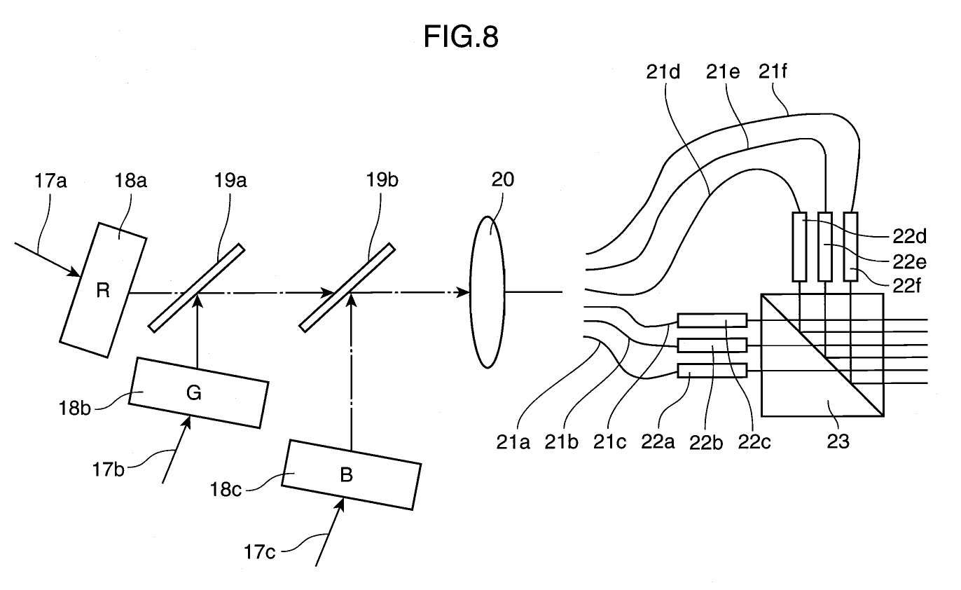

FIG. 8 is a section showing a schematic construction of an optical path switching member in a projection display apparatus according to a second embodiment of the invention. In FIG. 8, identified by 17a, 17b and 17c are red, green and blue lights emitted from unillustrated three laser light sources. Identified by 18a, 18b and 18c are light deflectors, which are preferably acousto-optical devices, electro-optical devices, galvanometer mirrors or micromirror devices. The three light deflectors 18a to 18c change propagation directions of incident lights by diffracting, refracting or reflecting action in accordance with external inputs. Identified by 19a, 19b are dichroic mirrors, by 20 a lens, by 21a to 21f six light guides and by 22a to 22f six rod integrators. Three rod integrators are vertically arranged and three rod integrators are transversely arranged, i.e. a total of six rod integrators are arranged such that longitudinal side surfaces thereof opposed to each other at a specified distance. Identified by 23 is a prism, which may be a glass prism or a polarizing prism. By using a polarizing prism, light utilization efficiency can be improved as compared to the case where a glass prism is used. The six rod integrators 22a to 22f are arranged adjacent to each other without any clearances defined therebetween in the same plane when viewed from an emergent side of the prism 23.

In FIG. 8, the red light 17a emitted from the unillustrated red laser light source passes through the dichroic mirrors 19a, 19b and is condensed by the lens 20 to be incident on any of the six light guides 21a to 21f after being deflected by the light deflector 18a. Further, the green light 17b emitted from the unillustrated green laser light source is reflected by the dichroic mirror 19a, passes through the dichroic mirror 19b and is condensed by the lens 20 to be incident on one of the six light guides 21a to 21f different from the light guide, on which the red light is incident, after being deflected by the light deflector 18b. The blue light 17c emitted from the unillustrated blue laser light source is reflected by the dichroic mirror 19b and is condensed by the lens 20 to be incident on one of the six light guides 21a to 21f different from the light guides, on which the red and green lights are incident, after being deflected by the light deflector 18c.

In the above operation, the light deflectors 18a to 18c execute such a control as to prevent the red light 17a, the green light 17b and the blue light 17c from being simultaneously incident on the same light guide and also such a control as to cause these lights to be cyclically incident on all the light guides within a specified period. The lights emitted from three of the six light guides 21a to 21f are incident on one ends of three of the six rod integrators 22a to 22f and undergo repeated multiple reflections and, then, emerge from the other ends. The light multiplexed by the prism 23 forms an image after passing through unillustrated lighting optical system, spatial light modulation element and projection lens.

The lighted state on the spatial light modulation element is as shown in FIG. 4. Since the light deflectors are provided for the respective red, green and blue lights in the second embodiment, irradiation periods of three primary color lights can be controlled for each of the regions 8a to 8f shown in FIG. 4 and color balance can be controlled for each screen region.

Further, the second embodiment eliminates the need for the mechanical vertical reciprocal movement of the mirror group every time the color wheel performs a predetermined rotation as in the first embodiment.

### Third Embodiment

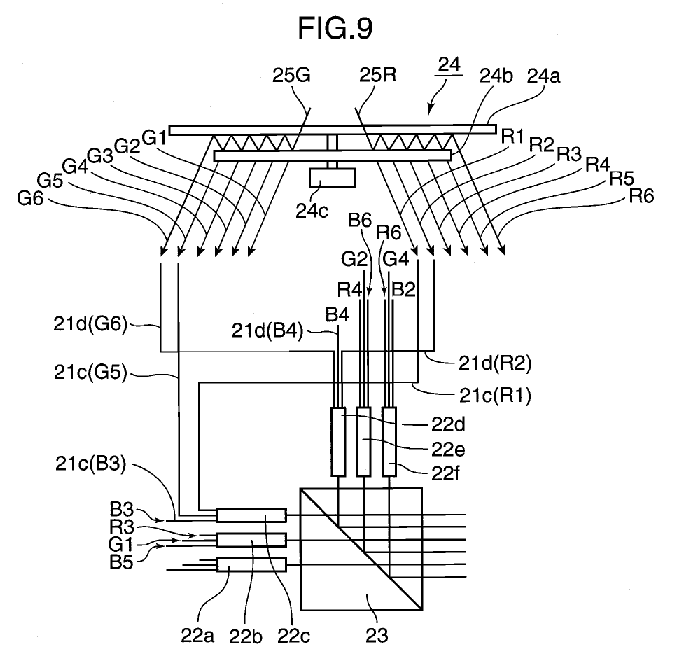

FIG. 9 is a section showing a schematic construction of an optical path switching member in a projection display apparatus according to a third embodiment of the invention. In the third embodiment, light emerges from a transmission surface of a second disc body while undergoing multiple reflections between rotating first and second disc bodies and is incident on a light guide to switch an optical path. Further, the third embodiment eliminates the need for dichroic mirrors as used in the first embodiment of the present invention by causing lights emitted from light sources of three colors, i.e. red, green and blue to be incident at different positions of the first disc body.

In FIG. 9, identified by 24 is a color wheel made up of first and second disc bodies 24a, 24b. The first and second disc bodies 24a, 24b rotate while being fixed to a rotary shaft of a motor 24c with the centers thereof aligned and a specified clearance defined therebetween. Identified by 25R is red light emitted from an unillustrated light source, and by 25G green light. It should be noted that blue light is not shown in FIG. 9 to clarify the graphical representation. Although a plurality of chief rays are shown to emerge from the second disc body 24b in order to make reflection optical paths of the red and green lights 25R, 25G more easily understandable, only one main ray actually emerges for each of the red, green and blue lights. Rod integrators 22a to 22f and a prism 23 have the same structures and functions as those shown in FIG. 8.

In FIG. 9, the red light 25R is obliquely incident on an inner circumferential region of the first disc body 24a and undergoes multiple reflections toward the outer circumference between an outer circumferential region of the second disc body 24b and a reflection surface of the first disc body 24a. The second disc body 24b has a region where transmission surfaces and reflection surfaces are formed, and the multiple-reflected red light is emitted as red lights R1 to R6 toward different positions from the transmission surfaces or outer side of the second disc body 24b, wherein, for example, the red light R1 is incident on one end of the light guide 21c(R1) and the red light R2 is incident on one end of the light guide 21d(R2). The red light R1 emitted from the other end of the light guide 21c(R1) is incident on the rod integrator 22c and the red light R2 emitted from the other end of the light guide 21d(R2) is incident on the rod integrator 22d.

The green light 25G is obliquely incident at a position of the inner circumferential region of the first disc body 24a different from the incident position of the red light 25R and undergoes multiple reflections toward the outer circumference between the outer circumferential region of the second disc body 24b and the reflection surface of the first disc body 24a. The multiple-reflected green light is emitted as green lights G1 to G6 toward different positions from the transmission surfaces or outer side of the second disc body 24b, wherein, for example, the green light G5 is incident on one end of the light guide 21c(G5) and the green light G6 is incident on one end of the light guide 21d(G6). The green light G5 emitted from the other end of the light guide 21c(G5) is incident on the rod integrator 22c and the green light G6 emitted from the other end of the light guide 21d(G6) is incident on the rod integrator 22d.

The unillustrated blue light is also emitted as blue lights B1 to B6 toward different positions from the second disc body 24b, wherein, for example, the blue light B3 is incident on one end of the light guide 21c(B3) and the blue light B4 is incident on one end of the light guide 21d(B4). The blue light B3 emitted from the other end of the light guide 21c(B3) is incident on the rod integrator 22c and the blue light B4 emitted from the other end of the light guide 21d(B4) is incident on the rod integrator 22d.

In this way, three light guides are connected with one rod integrator in correspondence with the red, green and blue lights. In FIG. 9, eighteen (2N²; N=3) light guides are shown merely by straight lines.

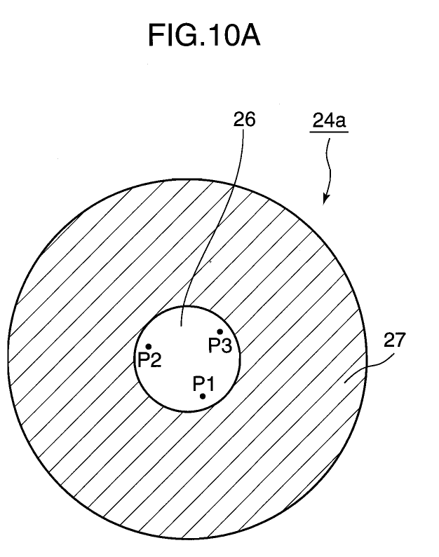

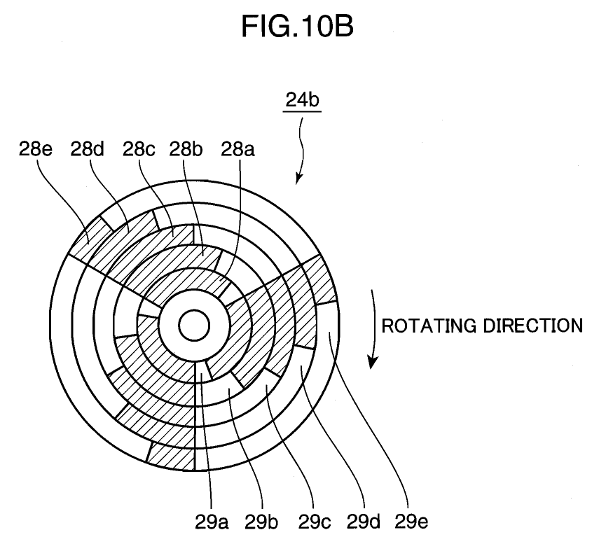

When the first and second disc bodies 24a, 24b are rotated by the motor 24c, the positions of the red, green and blue lights emitted from the second disc body 24b change, with the result that the respective color lights come to be incident on the different light guides as the first and second disc bodies 24a, 24b rotate. The structure and function of the color wheel 24 are described below with reference to FIGS. 10A and 10B.

FIG. 10A is a plan view showing a structure of the first disc body 24a constituting the color wheel 24. In FIG. 10A, the first disc body 24a is comprised of an inner circumferential region 26 for transmitting lights and an outer circumferential region for reflecting lights.

FIG. 10B is a plan view showing a structure of the second disc body 24b constituting the color wheel 24. In FIG. 10B, the second disc body 24b has a diameter smaller than that of the first disc body 24a and is circumferentially divided into 3(N) and radially divided into 5(2N−1), i.e. is divided into a total of 15(N(2N−1), wherein transmission surfaces 29a to 29e and reflection surfaces 28a to 28e for lights are circumferentially formed in the respective radially divided regions, areas of the transmission surfaces increase and areas of the reflection surfaces conversely decrease from the inner circumference toward the outer circumference.

In FIGS. 10A and 10B, the red light 25R (FIG. 9) is obliquely incident on a point P1 of the inner circumferential region 26 of the first disc body 24a to pass therethrough, is incident on the transmission surface 29a of the divided region of the second disc body 24b to pass therethrough, and is emitted as the red light R1 (FIG. 9) from the second disc body 24b. The green light 25G (FIG. 9) is obliquely incident on a point P2 of the inner circumferential region 26 of the first disc body 24a to pass therethrough and is emitted as the green light G1 (FIG. 9) similar to the red light. The blue light is obliquely incident on a point P3 of the inner circumferential region 26 of the first disc body 24a to pass therethrough and is emitted as the blue light B1 (FIG. 9) similar to the red light.

Next, when the motor 24c (FIG. 9) is rotated in a direction of arrow, the red light R25 incident on the point P1 of the inner circumferential region 26 of the first disc body 24a is reflected in a direction toward the outer circumference by the reflection surface 28a of the divided region of the second disc body 24b, reflected by the first disc body 24a, incident on the transmission surface 29b of the divided region of the second disc body 24b to pass therethrough, and emitted as the red light R2 (FIG. 9) from the second disc body 24b. The green and blue lights also similarly act.

When the motor 24c further rotates, the red light incident on the point P1 of the inner circumferential region 26 of the first disc body 24a is reflected in a direction toward the outer circumference by the reflection surface 28a of the divided region of the second disc body 24b, reflected by the first disc body 24a, reflected by the reflection surface 28b of the divided region of the second disc body 24b, reflected by the first disc body 24a, incident on the transmission surface 29c of the divided region of the second disc body 24b to pass therethrough, and emitted as the red light R3 (FIG. 9) from the second disc body 24b. The green and blue lights also similarly act.

In this way, when the red, green and blue lights are obliquely incident at the different positions (points P1, P2, P3) of the inner circumferential region 26 of the first disc body 24a of the color wheel 24, they are divided into the transmitted lights and the reflected lights by the second disc body 24b having the transmission surfaces and the reflection surfaces in the circumferential and radial regions, wherein the reflected lights are reflected by the outer circumferential region 27 of the first disc body 24a. By repeating these, the respective lights emerge from the transmission surfaces of the respective radial regions of the second disc body 24b and the outer side thereof while the positions thereof are changed every time the color wheel 24 performs a predetermined rotation.

As described above, the third embodiment eliminates the needs for the mechanical vertical reciprocal movement of the mirror group every time the color wheel performs a predetermined rotation as in the first embodiment; for the deflection of the red, green and blue lights by the three light deflectors as in the second embodiment; and for the dichroic mirrors for causing the red, green and blue lights to propagate along the common optical axis as in the first and second embodiments.

### Fourth Embodiment

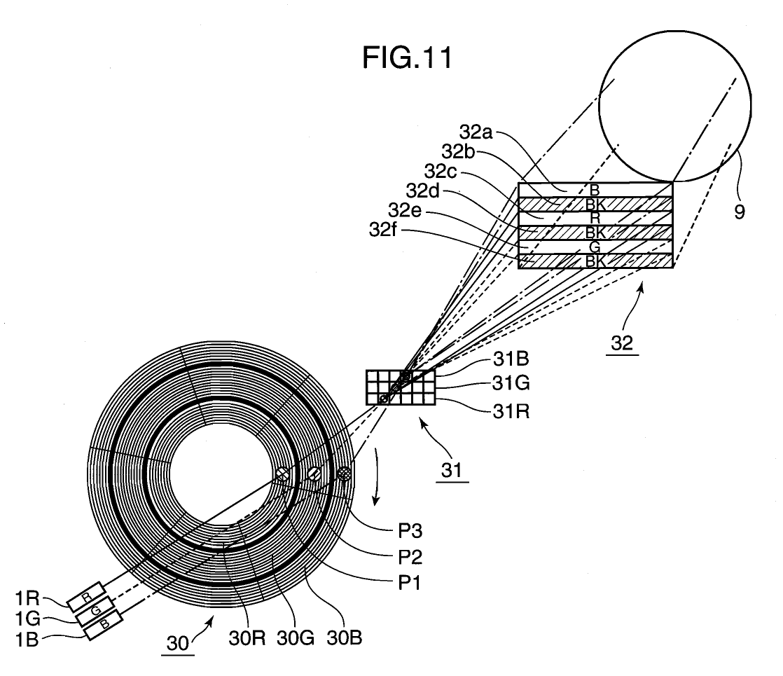

FIG. 11 is a schematic construction diagram of a projection display apparatus according to a fourth embodiment of the invention. In FIG. 11, identified by 30 is a grating wheel including three radially divided annular regions 30R, 30G and 30B. Red light emitted from a red laser light source 1R, green light emitted from a green laser light source 1G and blue light emitted from a blue laser light source 1B are respectively incident on the annular regions 30R, 30G and 30B. Each annular region 30R to 30B includes 6(2N) circumferentially divided regions, and concentric gratings with different pitches are formed in each region. Identified by 31 is a hologram comprised of holographic diffusers arranged in a 3×6 (N×2N) matrix. Identified by 31R, 31G and 31B are hologram rows in each of which six holographic diffusers are aligned and on which the red, green and blue lights diffracted by the annular regions 30R, 30G and 30B of the grating wheel 30 are incident. Identified by 32 is a spatial light modulation element. Identified by 32a to 32f are divided regions of the spatial light modulation element 32. The holographic diffusers constituting the hologram 31 makes light quantity distributions uniform by diffusing the incident lights and irradiate the regions 32a to 32f of the spatial light modulation element 32 with beams having shapes corresponding to the respective regions.

Red light incident on a point P1 of the annular region 30R of the grating wheel 30 is diffracted by the gratings in the form of concentric circles to be incident on the hologram row 31R of the hologram 31. Green light incident on a point P2 of the annular region 30G of the grating wheel 30 is diffracted by the gratings in the form of concentric circles to be incident on the hologram row 31G of the hologram 31. Blue light incident on a point P3 of the annular region 30B of the grating wheel 30 is diffracted by the gratings in the form of concentric circles to be incident on the hologram row 31B of the hologram 31.

When the grating wheel 30 rotates, the pitches of the gratings in the form of concentric circles formed in the annular regions 30R, 30G, 30B change in the respective divided regions. Thus, diffraction angles of the red, green and blue lights change to change the incident positions on the hologram rows 31R, 31G and 31B. When the grating wheel 30 performs one rotation, the red, green and blue lights scan the hologram rows 31R, 31G and 31B of the hologram 31. Each of the hologram rows 31R, 31G and 31B is formed with six holographic diffusers, which are in a one-to-one correspondence with the regions 32a to 32f of the spatial light modulation element 32.

When the red, green and blue lights scan the hologram rows 31R, 31G and 31B, the regions 32a to 32f of the spatial light modulation element 32 are also scanned to be illuminated as described in FIG. 4, wherefore a color image is formed. Although the word “scan” is used here, it is not necessary to continuously move the lights and it is also possible to discretely illuminate the regions, for example, in an order of 32a, 32c, 32e, 32b, 32d and 32f.

As described above, according to the fourth embodiment, it is possible to make the light quantities uniform, to irradiate beams and to simplify the optical elements. As a modification of the fourth embodiment, the grating wheel 30 may be additionally provided with the function of the holographic diffusers, whereby the optical elements can be more simplified.

Further, the fourth embodiment eliminates the needs for the mechanical vertical reciprocal movement of the mirror group every time the color wheel performs a predetermined rotation as in the first embodiment; for the deflection of the red, green and blue lights by the three light deflectors as in the second embodiment; and for the dichroic mirrors for causing the red, green and blue lights to propagate along the common optical axis as in the first and second embodiments.

### Fifth Embodiment

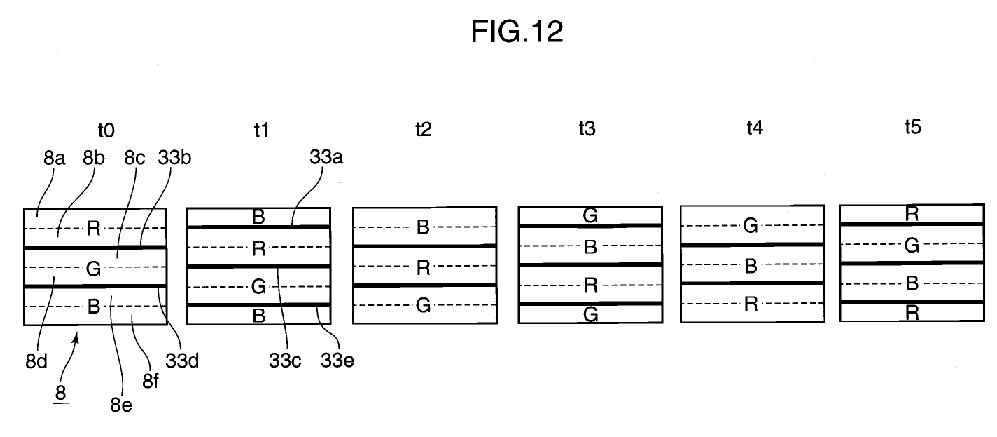

A projection display apparatus according to a fifth embodiment of the present invention differs from that of the fourth embodiment only in the lighted states of three primary color lights of red, green and blue on the spatial light modulation element. Thus, the illumination on the spatial light modulation element 8 is described with reference to FIG. 12. FIG. 12 shows lighted states at the respective times similar to FIG. 4. In FIG. 12, identified by 33a is a near boundary region between the regions 8a and 8b and comprised of four to six pixel lines located at the opposite sides of a boundary between the regions 8a and 8b. Identified by 33b to 33e are respectively near boundary regions between the regions 8b and 8c, between the regions 8c and 8d, between the regions 8d and 8e and between the regions 8e and 8f. In FIG. 12, what is different from FIG. 4 is only the irradiation regions of the illumination lights.

At time t0, the regions 8a, 8b of the spatial light modulation element 8 are irradiated with the red light, the regions 8c, 8d with the green light and the regions 8e, 8f with the blue light. The spatial light modulation element 8 is turned off in the near border regions 33b, 33d to block the lights.

When the grating wheel 30 (FIG. 11) performs a ⅙ rotation in a direction of arrow from time t0, the red, green and blue lights are incident on the regions of the grating wheel 30 with different grating pitches at time t1, whereby the diffraction angles change and the red, green and blue lights are incident on the different holographic diffusers of the hologram rows 31R, 31G and 31B of the hologram 31 to switch the lighted state on the spatial light modulation element 8 as shown, and the spatial light modulation element 8 is turned off in the near border regions 33a, 33c and 33e to block the lights.

Thereafter, if the rotation of the grating wheel 30 is repeated, the state at time t0 is returned again via states at times t2, t3, t4 and t5. By repeating this one cycle, the spatial light modulation element 8 comes to have the entire surface thereof irradiated with the three primary color lights of red, green and blue, and a color image can be formed by inputting image color signals corresponding to the illumination lights to the regions 8a to 8f in synchronism with the illumination lights. A color projected image can be formed by focusing the image of the spatial light modulation element 8 by means of a projection lens 9.

As described above, according to the fifth embodiment, areas of the regions where no image is to be displayed can be reduced to suppress flickering by turning the spatial light modulation element 8 off in the near border regions of the irradiation regions of the red, green and blue lights. Since the irradiation areas of the illumination lights increase, strength per unit area can be decreased to improve the uniformity of the light quantity distributions and can also suppress the thermal and photochemical damages of the spatial light modulation element 8.

### Sixth Embodiment

A sixth embodiment of the present invention is for realizing the lighted state on the spatial light modulation element 8 in the fifth embodiment shown in FIG. 12 by another construction. To this end, the light deflectors, dichroic mirrors, lens, rod integrators, light guides (first light guides) and prism in the second embodiment are used, light splitting elements and second light guides are provided, and lights are caused to be incident on the rod integrators from the first light guides via the light splitting elements and the second light guides.

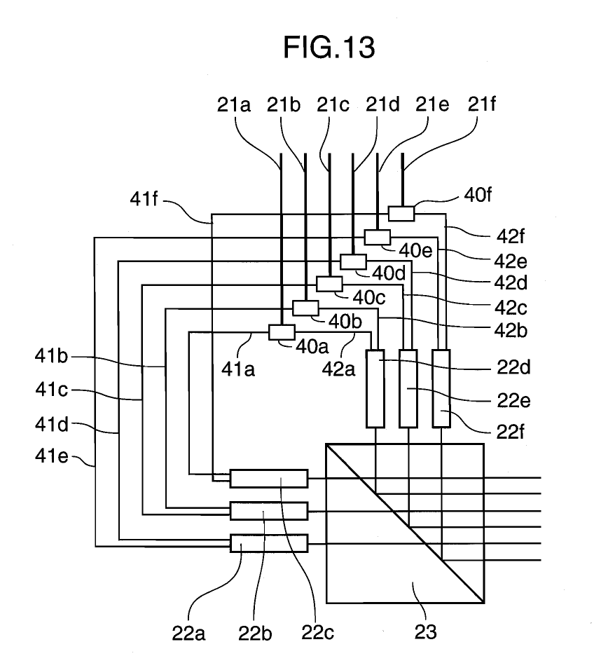

FIG. 13 is a diagram showing a schematic partial construction of an optical path switching member in a projection display apparatus according to the sixth embodiment of the invention. In FIG. 13, the other ends of 6(2N) first light guides 21a to 21f are respectively connected with incident ends of 6(2N) light splitting elements 40a to 40f, which receive lights emitted from the other ends of the first light guides 21a to 21f. The light splitting elements 40a to 40f emit the lights of the same colors as those incident from the other ends of the first light guides 21a to 21f while splitting them in one direction and another direction. One ends of second light guides 41a and 42a, 41b and 42b, 41c and 42c, 41d and 42d, 41e and 42e, 41f and 42f are connected with the emergent ends of the light splitting elements 40a, 40b, 40c, 40d, 40e and 40f in the one and other directions.

The lights of the same color emitted from the other ends of the second light guides 41a, 42a are respectively incident on the rod integrators 22c, 22d. The lights of the same color emitted from the other ends of the second light guides 41b, 42b are respectively incident on the rod integrators 22b, 22e. The lights of the same color emitted from the other ends of the second light guides 41c, 42c are respectively incident on the rod integrators 22b, 22e. The lights of the same color emitted from the other ends of the second light guides 41d, 42d are respectively incident on the rod integrators 22a, 22e. The lights of the same color emitted from the other ends of the second light guides 41e, 42e are respectively incident on the rod integrators 22a, 22f. The lights of the same color emitted from the other ends of the second light guides 41f, 42f are respectively incident on the rod integrators 22c, 22f.

With such a construction, it is supposed that, for example, the red light deflected by the light deflector 18a (FIG. 8) is incident on one end of the first light guide 21a, the green light deflected by the light deflector 18b (FIG. 8) is incident on one end of the first light guide 21c and the blue light deflected by the light deflector 18c (FIG. 8) is incident on one end of the first light guide 21e.

The red light emitted from the other end of the first light guide 21a is incident on one end of the rod integrator 22c via the second light guide 41a from the emergent end of the light splitting element 41a in the one direction, and the red light emitted from the other end passes through a prism 23. Further, the red light emitted from the other end of the first light guide 21a is incident on the rod integrator 22d via the second light guide 42a from the emergent end of the light splitting element 41a in the other direction, and the red light emitted from the other end is reflected by the prism 23.

The green light emitted from the other end of the first light guide 21c is incident on one end of the rod integrator 22b via the second light guide 41c from the emergent end of the light splitting element 41c in the one direction, and the green light emitted from the other end passes through the prism 23. Further, the green light emitted from the other end of the first light guide 21c is incident on the rod integrator 22e via the second light guide 42c from the emergent end of the light splitting element 41c in the other direction, and the green light emitted from the other end is reflected by the prism 23.

The blue light emitted from the other end of the first light guide 21e is incident on one end of the rod integrator 22a via the second light guide 41e from the emergent end of the light splitting element 41e in the one direction, and the blue light emitted from the other end passes through the prism 23. Further, the blue light emitted from the other end of the first light guide 21e is incident on the rod integrator 22f via the second light guide 42e from the emergent end of the light splitting element 41e in the other direction, and the blue light emitted from the other end is reflected by the prism 23.

The multiplexed red, green and blue lights emitted from the prism 23 are irradiated onto the spatial light modulation element 8 (FIG. 1) to obtain the lighted state at time t0 shown in FIG. 12 referred to in the fifth embodiment. In this way, the red, green and blue lights are incident on the different first light guides at specified time intervals, whereby the lighted states at times t1 to t5 shown in FIG. 12 can be realized.

As described above, according to the sixth embodiment, the advantages of the second and fifth embodiments can be obtained.

The characteristic construction of the present invention is summarized as follows.

A lighting apparatus according to the present invention comprises N laser light sources for emitting lights in N wavelength ranges different from each other; an optical path switching member for dividing the lights emitted from the N laser light sources into spatially different irradiation regions separated by separation regions for the respective wavelength ranges and successively switching to the different irradiation regions at specified time intervals; and a lighting optical system for irradiating the lights emitted from the optical path switching member.

According to this construction, by dividing the lights in the different wavelength ranges into the spatially different irradiation regions with the separation regions and successively switching to the different irradiation regions at the specified time intervals, the illumination lights can immediately move to the specified irradiation regions at the specified time intervals to be constantly present in the irradiation regions without requiring a complicated optical system for moving the illumination lights at a constant speed as in the prior art. Therefore, light utilization efficiency can be improved by a simple optical system.

In the lighting apparatus according to the present invention, the optical path switching member preferably includes a color wheel for rotating about an axis to emit the lights in the respective wavelength ranges to N different positions every time making a predetermined rotation; N rod integrators having a rectangular parallelepipedic shape, arranged at specified spacings in a vertical direction with longitudinal side surfaces thereof opposed to each other, receiving the lights in the respective wavelength ranges emitted to the N different positions from the color wheel at one ends thereof at one side and emitting the received lights from the other ends thereof; and a mirror group for reciprocally moving upward or downward every time the color wheel performs the predetermined rotation to reflect the lights emitted from the rod integrators and orient the reflected lights toward the lighting optical system.

According to this construction, the lights in the respective wavelength ranges (red, green and blue lights) are emitted from the color wheel while being divided into different positions every time the color wheel performs the predetermined rotation, and are successively switched to irradiate the irradiation regions by the vertical reciprocal movements of the mirror group.

In this case, the color wheel preferably includes a first disc body having an inner circumferential region on which lights emitted from the N laser light sources are obliquely incident to pass therethrough and an outer circumferential region for reflecting the lights; and a second disc body coaxially arranged below a light emergent side of the first disc body, having a diameter smaller than that of the first disc body, circumferentially divided into N and radially divided into (N−1), i.e. divided into a total of N×(N−1) regions for the respective wavelength ranges, transmitting the lights in a specified wavelength range emitted from the inner circumferential region of the first disc body or reflected by the outer circumferential region in the respective divided regions to emit the lights in the specified wavelength range and reflecting the lights in the other wavelength ranges in directions toward the outer circumference of the first disc body.

According to this construction, when the lights in the respective wavelength ranges (red, green and blue lights) are obliquely incident on the inner circumferential region of the first disc body, they are split into transmitted lights and reflected lights by the second disc body having a wavelength selecting property in the circumferential and radial regions and the reflected lights are reflected by the outer circumferential region of the first disc body. By repeating these, the lights are emitted from the inner circumferential region, the outer circumferential region and the outside of the second disc body while the positions thereof are changed every time the color wheel performs the predetermined rotation.

In the lighting apparatus according to the present invention, it is preferable that the optical path switching member includes N light deflecting elements for deflecting the lights in the different wavelength ranges emitted from the N laser light sources toward N different positions out of 2N different positions at the specified time intervals; 2N light guides for receiving the lights deflected toward the N different positions by the N light deflecting elements at one ends thereof and emitting the received lights from the other ends thereof; 2N rod integrators having a rectangular parallelepipedic shape, having N rod integrators vertically arranged and N rod integrators transversely arranged at specified spacings with longitudinal side surfaces thereof opposed to each other, receiving the lights in the respective wavelength ranges emitted from the other ends of the N light guides out of the 2N light guides at one ends thereof and emitting the lights from the other ends thereof; and a prism for transmitting the lights emitted from the other ends of the N vertically arranged rod integrators and reflecting the lights emitted from the other ends of the N transversely arranged rod integrators to orient the lights toward the lighting optical system, and that the 2N rod integrators are arranged adjacent to each other in a same plane without defining any clearance therebetween when viewed from a light emergent side of the prism.

According to this construction, the lights in the different wavelength ranges are deflected toward the N different light guides out of the 2N light guides at the specified time intervals by the N light deflecting elements, are emitted from the respective N vertically arranged rod integrators via the N light guides to pass through the prism at a certain time and are emitted from the respective N transversely arranged rod integrators to be reflected by the prism at the next time after the lapse of a specified time, whereby the irradiation regions are switched at specified time intervals. This eliminates the need for the vertical mechanical reciprocal movement of the mirror group every time the color wheel performs the predetermined rotation to switch the irradiation regions at the specified time intervals as described above.

In the lighting apparatus according to the present invention, it is preferable that the optical path switching member includes a color wheel for rotating about an axis to cause the lights in the respective wavelength ranges emitted from the N laser light sources to be obliquely incident at N circumferentially different positions at an inner circumferential side for the respective wavelength ranges and to emit the lights to 2N different positions during a predetermined rotation from the inner circumferential side toward an outer circumferential side as being rotated; 2N² light guides for receiving the lights emitted to the 2N positions for the respective wavelength ranges at one ends thereof and emitting the lights from the other ends thereof; 2N rod integrators having a rectangular parallelepipedic shape, having N rod integrators vertically arranged and N rod integrators transversely arranged at specified spacings with longitudinal side surfaces thereof opposed to each other, receiving the lights in each wavelength range individually emitted from the 2N light guides corresponding to the 2N positions at one ends thereof and emitting the lights from the other ends thereof; and a prism for transmitting the lights emitted from the other ends of the N vertically arranged rod integrators and reflecting the lights emitted from the other ends of the N transversely arranged rod integrators to orient the lights toward the lighting optical system, and that the 2N rod integrators are arranged adjacent to each other in a same plane without defining any clearance therebetween when viewed from a light emergent side of the prism.

According to this construction, the lights in the different wavelength ranges emitted from the N laser light sources are directly incident on the color wheel along different optical paths, are emitted to the 2N different positions every time the color wheel performs the predetermined rotation, are emitted from the respective N vertically arranged rod integrators via the light guides to pass through the prism at a certain time and are emitted from the respective N transversely arranged rod integrators to be reflected by the prism at the next time after the lapse of a specified period, whereby the irradiation regions are switched at the specified time intervals. This eliminates the need for the vertical mechanical reciprocal movement of the mirror group every time the color wheel performs the predetermined rotation, the deflection of the lights in the different wavelength ranges by the N light deflecting elements or the optical elements for causing the lights in the respective wavelength ranges to propagate along a common optical axis in order to switch the irradiation regions at the specified time intervals as described above.

In this case, the color wheel preferably includes a first disc body having an inner circumferential region on which lights emitted from the N laser light sources are obliquely incident to pass therethrough and an outer circumferential region for reflecting the lights; and a second disc body coaxially arranged below a light emergent side of the first disc body, having a diameter smaller than that of the first disc body, circumferentially divided into N and radially divided into (2N−1), i.e. divided into a total of N×(2N−1) regions, and having transmission surfaces and reflection surfaces for light circumferentially formed in the respective radially divided regions such that areas of the transmission surfaces increase and areas of the reflection surfaces decrease from the inner circumference to the outer circumference.

According to this construction, if the lights in the respective wavelength ranges (red, green and blue lights) are obliquely incident at different positions in the inner circumferential region of the first disc body of the color wheel, they are split into transmitted lights and reflected lights by the second disc body having the transmission surfaces and the reflection surfaces in the circumferential and radial regions and the reflected lights are reflected by the outer circumferential region of the first disc body. By repeating these, the reflected lights are emitted from the transmission surfaces of the respective radial regions and the outer side of the second disc body while the positions thereof are changed every time the color wheel performs the predetermined rotation.

In the lighting apparatus according to the present invention, the specified spacing between the rod integrators preferably corresponds to the vertical width of the separation regions.

According to this construction, in the case of arranging the rod integrator only in the vertical direction, the vertical width of the separation regions is specified by the spacing between the rod integrators and the vertical width of the irradiation regions is specified by that of the rod integrator. Alternatively, in the case of arranging the rod integrator in the vertical and transverse directions, the vertical width of the separation regions is specified by the spacing between the rod integrators and the vertical width or transverse width of the rod integrators and the vertical width of the irradiation regions is specified by the vertical width or transverse width of the rod integrators.

In the lighting apparatus according to the present invention, the optical path switching member preferably includes a grating wheel for rotating about an axis to diffract the lights in the different wavelength ranges emitted from the N laser light sources toward N different positions in a column direction for each wavelength range and diffracting the lights in the different wavelength ranges toward 2N different positions in a row direction every time the grating wheel performs a predetermined rotation; and a hologram including holographic diffusers arranged in a N×2N matrix, receiving the lights diffracted by the grating wheel by the holographic diffusers in different rows for the respective wavelength ranges and in different columns every time the grating wheel performs the predetermined rotation to orient the lights toward the lighting optical system while converting the lights into diffused lights.

According to this construction, if the lights in the different wavelength ranges emitted from the N laser light sources are respectively incident on the grating wheel, they are emitted while being divided into the N different positions in the column direction for each wavelength range and are also emitted to be incident on the hologram with the N×2N arrangement while being switched to the 2N different positions in the row direction every time the grating wheel performs the predetermined rotation. The hologram with the N×2N arrangement diffracts the lights in the different wavelength ranges in the row direction to irradiate the vertically arranged irradiation regions with the separation regions. This eliminates the need for the vertical mechanical reciprocal movement of the mirror group every time the color wheel performs the predetermined rotation, the deflection of the lights in the different wavelength ranges by the N light deflecting elements or the optical elements for causing the lights in the respective wavelength ranges to propagate along a common optical axis in order to switch the irradiation regions at the specified time intervals.

In this case, it is preferable that the grating wheel includes N annular regions different in a radial direction for the respective wavelength ranges; that each of the N annular regions is circumferentially divided into 2 N regions; and that diffraction gratings in the form of concentric circles with different pitches are formed in each of the 2N regions.

According to this construction, the lights in the different wavelength ranges are diffracted toward different positions in the column direction due to differences in the diffraction angles of the respective annular regions in the radial direction of the grating wheel and are diffracted toward different positions in the row direction, every time the grating wheel performs the predetermined rotation, due to differences in the diffraction angles of regions obtained by dividing the respective annular regions in the circumferential direction.

In the lighting apparatus according to the present invention, areas of the irradiation regions for the lights in the respective wavelength ranges are same as those of the separation areas.

According to this construction, the positions of the irradiation regions and those of the separation regions can be easily and immediately switched at specified time intervals, and light utilization efficiency can be improved.

In the lighting apparatus according to the present invention, it is preferable that the optical path switching member preferably includes N light deflecting elements for deflecting the lights in the different wavelength ranges emitted from the N laser light sources toward N different positions out of 2N different positions at the specified time intervals; 2N first light guides for receiving the lights deflected toward the N different positions by the N light deflecting element at one ends thereof and emitting the lights from the other ends thereof; 2N light splitting elements connected with the other ends of the respective 2N first light guides to receive the lights and adapted to emit the lights in the same wavelength ranges in one direction and the other direction; 4N second light guides having one ends thereof connected with the emergent ends of the respective 2N light splitting elements in the one and the other directions to receive the lights in the same wavelength range emitted from the light splitting elements in the one and the other directions at the one ends thereof and to emit the lights in the same wavelength range from the other ends thereof in the one and the other directions; 2N rod integrators having a rectangular parallelepipedic shape, having N rod integrators vertically arranged and N rod integrators transversely arranged at specified spacings with longitudinal side surfaces thereof opposed to each other, receiving the lights emitted from the other ends of the N pairs of the second light guides out of the 4N second light guides in the one direction at one ends of the N vertically arranged rod integrators and emitting the lights in the one direction from the other ends thereof, receiving the lights emitted from the other ends of the N pairs of the second light guides in the other direction at one ends of the N transversely arranged rod integrators and emitting the lights in the other direction from the other ends thereof; and a prism for transmitting the lights emitted from the other ends of the N vertically arranged rod integrators and reflecting the lights emitted from the other ends of the N transversely arranged rod integrators to orient the lights toward the lighting optical system; and that the 2N rod integrators are arranged adjacent to each other in a same plane without defining any clearance therebetween when viewed from a light emergent side of the prism.

According to this construction, the lights in the different wavelength ranges are deflected toward the N different first light guides out of the 2N first light guides at the specified time intervals by the N light deflecting elements and are emitted from the respective 2N vertically arranged and transversely arranged rod integrators via the N first light guides, the N light splitting elements and the 2N second light guides to pass through and to be reflected by the prism at a certain time and, at the next time after the lapse of a specified time, the lights incident on the N vertically arranged rod integrators are successively switched to be respectively emitted from the 2N vertically arranged and transversely arranged rod integrators to pass through and to be reflected by the prism, whereby the irradiation regions are switched at specified time intervals. This eliminates the need for the vertical mechanical reciprocal movement of the mirror group every time the color wheel performs the predetermined rotation to switch the irradiation regions at the specified time intervals as described above.

A display apparatus according to the present invention comprises the lighting apparatus according to the present invention including neither the grating wheel nor the hologram; a spatial light modulation element for receiving and modulating an illumination light from the lighting apparatus; and a control circuit for transmitting image color signals corresponding to wavelength ranges to the spatial light modulation element in correspondence with light irradiation regions of the spatial light modulation element in the respective wavelength ranges.

According to this construction, a display apparatus having the light utilization efficiency thereof improved by a simple optical system can be easily realized by incorporating the above lighting apparatus.

Another display apparatus according to the present invention comprises the lighting apparatus according to the present invention including the grating wheel and the hologram; a spatial light modulation element for receiving and modulating an illumination light from the lighting apparatus; and a control circuit for transmitting image color signals corresponding to wavelength ranges to the spatial light modulation element in correspondence with light irradiation regions of the spatial light modulation element in the respective wavelength ranges.

According to this construction, a display apparatus having the light utilization efficiency thereof improved by a simple optical system can be easily realized by incorporating the above lighting apparatus.

In this case, it is preferable that areas of the irradiation regions for the lights in the respective wavelength ranges are set larger than those of the separation regions; that the control circuit controls the spatial light modulation element such that the lights are blocked in near boundary regions of the irradiation regions for the lights in the respective wavelength ranges; and that the near boundary regions are set to cross over the separation regions.

According to this construction, the flickering of images can be suppressed by reducing the areas of the separation regions, and it is possible to reduce light intensity per unit area on the spatial light modulation element, to improve the uniformity of light quantity distributions and to suppress thermal and chemical damages on the spatial light modulation element by increasing the areas of the irradiation regions of images.

In the display apparatus according to the present invention, the spatial light modulation element is preferably a micromirror device or a reflective liquid crystal panel.

According to this construction, light utilization efficiency can be further improved by a simple optical system.

A projection display apparatus according to the present invention comprises the display apparatus according to the present invention, and a projection optical system for projecting a light modulated by the spatial light modulation element onto a screen.

According to this construction, a projection display apparatus having the light utilization efficiency thereof improved by a simple optical system can be easily realized by using the display apparatus having the above lighting apparatus incorporated therein.

A lighting method according to the present invention comprises the steps of emitting lights in at least three different wavelength ranges; and dividing the emitted lights into spatially different irradiation regions separated by separation regions for the respective wavelength ranges and successively switching to the different irradiation regions at specified time intervals.

According to this construction, the lights in the different wavelength ranges are divided into the respective spatially different irradiation regions with the separation regions and are successively switched to the different irradiation regions at the specified time intervals, whereby the illumination light can be immediately moved to the specified irradiation regions at the specified time intervals to be constantly present in the irradiation regions without requiring a complicated optical system for moving the illumination lights at a constant speed as in the prior art. This enables light utilization efficiency to be improved by a simple optical system.

An image display method according to the present invention comprises the steps in the lighting method according to the present invention, and the step of spatially modulating the illumination lights in the respective wavelength ranges in accordance with image color signals corresponding to the wavelength ranges.

According to this construction, an image display method for improving light utilization efficiency by a simple optical system can be easily realized by using the above lighting method.

An image projection method according to the present invention comprises the steps in the image display method according to the present invention, and the step of projecting the spatially modulated lights onto a screen.

According to this construction, an image projection method having the light utilization efficiency thereof improved by a simple optical system can be easily realized by using the above image display method adopting the above lighting method.

### INDUSTRIAL APPLICABILITY

A lighting apparatus according to the present invention has an advantage of being able to improve light utilization efficiency by a simple optical system and can change irradiation regions of three primary color lights at specified time intervals. Thus, it is applicable to a liquid crystal display apparatuses for color images, projection display apparatuses for projecting color images onto large-size screens, etc.

1-19. (canceled)

20. A lighting apparatus, comprising:
N laser light sources for emitting lights in N wavelength ranges different from each other;
an optical path switching member for dividing the lights emitted from the N laser light sources into spatially different irradiation regions separated by separation regions for the respective wavelength ranges and successively switching to the different irradiation regions at specified time intervals; and
a lighting optical system for irradiating the light emitted from the optical path switching member.

21. A lighting apparatus according to claim 20, wherein the optical path switching member includes:
a color wheel for rotating about an axis to emit the lights in the respective wavelength ranges to N different positions every time making a predetermined rotation;
N rod integrators having a rectangular parallelepipedic shape, arranged at specified spacings in a vertical direction with longitudinal side surfaces thereof opposed to each other, receiving the lights in the respective wavelength ranges emitted to the N different positions from the color wheel at one ends thereof at one side and emitting the received lights from the other ends thereof; and
a mirror group for reciprocally moving upward or downward every time the color wheel performs the predetermined rotation to reflect the lights emitted from the rod integrators and orient the reflected toward the lighting optical system.

22. A lighting apparatus according to claim 21, wherein the color wheel includes:
a first disc body having an inner circumferential region on which lights emitted from the N laser light sources are obliquely incident to pass therethrough and an outer circumferential region for reflecting the lights; and
a second disc body coaxially arranged below a light emergent side of the first disc body, having a diameter smaller than that of the first disc body, circumferentially divided into N and radially divided into (N−1), i.e. divided into a total of N×(N−1) regions for the respective wavelength ranges, transmitting the lights in a specified wavelength range emitted from the inner circumferential region of the first disc body or reflected by the outer circumferential region in the respective divided regions to emit the lights in the specified wavelength range and reflecting the lights in the other wavelength ranges in directions toward the outer circumference of the first disc body.

23. A lighting apparatus according to claim 20, wherein:
the optical path switching member includes:
N light deflecting elements for deflecting the lights in the different wavelength ranges emitted from the N laser light sources toward N different positions out of 2N different positions at the specified time intervals;
2N light guides for receiving the lights deflected toward the N different positions by the N light deflecting element at one ends thereof and emitting the received lights from the other ends thereof;
2N rod integrators having a rectangular parallelepipedic shape, having N rod integrators vertically arranged and N rod integrators transversely arranged at specified spacings with longitudinal side surfaces thereof opposed to each other, receiving the lights in the respective wavelength ranges emitted from the other ends of the N light guides out of the 2N light guides at one ends thereof and emitting the lights from the other ends thereof; and
a prism for transmitting the lights emitted from the other ends of the N vertically arranged rod integrators and reflecting the lights emitted from the other ends of the N transversely arranged rod integrators to orient the lights toward the lighting optical system, and
the 2N rod integrators are arranged adjacent to each other in a same plane without defining any clearance therebetween when viewed from a light emergent side of the prism.

24. A lighting apparatus according to claim 20, wherein:
the optical path switching member includes:
a color wheel for rotating about an axis to cause the lights in the respective wavelength ranges emitted from the N laser light sources to be obliquely incident at N circumferentially different positions at an inner circumferential side for the respective wavelength ranges and to emit the lights to 2N different positions during a predetermined rotation from the inner circumferential side toward an outer circumferential side as being rotated;
2N² light guides for receiving the lights emitted to the 2N positions for the respective wavelength ranges at one ends thereof and emitting the lights from the other ends thereof;
2N rod integrators having a rectangular parallelepipedic shape, having N rod integrators vertically arranged and N rod integrators transversely arranged at specified spacings with longitudinal side surfaces thereof opposed to each other, receiving the lights in each wavelength range individually emitted from the 2N light guides corresponding to the 2N positions at one ends thereof and emitting the lights from the other ends thereof; and
a prism for transmitting the lights emitted from the other ends of the N vertically arranged rod integrators and reflecting the lights emitted from the other ends of the N transversely arranged rod integrators to orient the lights toward the lighting optical system, and
the 2N rod integrators are arranged adjacent to each other in a same plane without defining any clearance therebetween when viewed from a light emergent side of the prism.

25. A lighting apparatus according to claim 24, wherein the color wheel includes:
a first disc body having an inner circumferential region on which lights emitted from the N laser light sources are obliquely incident to pass therethrough and an outer circumferential region for reflecting the lights; and
a second disc body coaxially arranged below a light emergent side of the first disc body, having a diameter smaller than that of the first disc body, circumferentially divided into N and radially divided into (2N−1), i.e. divided into a total of N×(2N−1) regions, and having transmission surfaces and reflection surfaces for light circumferentially formed in the respective radially divided regions such that areas of the transmission surfaces increase and areas of the reflection surfaces decrease from the inner circumference to the outer circumference.

26. A lighting apparatus according to claim 21, wherein the specified spacing between the rod integrators corresponds to the vertical width of the separation regions.

27. A lighting apparatus according to claim 20, wherein the optical path switching member includes:
a grating wheel for rotating about an axis to diffract the lights in the different wavelength ranges emitted from the N laser light sources toward N different positions in a column direction for each wavelength range and diffracting the lights in the different wavelength ranges toward 2N different positions in a row direction every time the grating wheel performs a predetermined rotation; and
a hologram including holographic diffusers arranged in an N×2N matrix, receiving the lights diffracted by the grating wheel by the holographic diffusers in different rows for the respective wavelength ranges and in different columns every time the grating wheel performs the predetermined rotation to orient the lights toward the lighting optical system while converting the lights into diffused lights.

28. A lighting apparatus according to claim 27, wherein:
the grating wheel includes N annular regions different in a radial direction for the respective wavelength ranges;
each of the N annular regions is circumferentially divided into 2 N regions; and
diffraction gratings in the form of concentric circles with different pitches are formed in each of the 2N regions.

29. A lighting apparatus according to claim 20, wherein areas of the irradiation regions for the lights in the respective wavelength ranges are same as the areas of the separation regions.

30. A lighting apparatus according to claim 20, wherein:
the optical path switching member includes:
N light deflecting elements for deflecting the lights in the different wavelength ranges emitted from the N laser light sources toward N different positions out of 2N different positions at the specified time intervals;
2N first light guides for receiving the lights deflected toward the N different positions by the N light deflecting element at one ends thereof and emitting the lights from the other ends thereof;
2N light splitting elements connected with the other ends of the respective 2N first light guides to receive the lights and adapted to emit the lights in the same wavelength ranges in one direction and the other direction;
4N second light guides having one ends thereof connected with the emergent ends of the respective 2N light splitting elements in the one and the other directions to receive the lights in the same wavelength range emitted from the light splitting elements in the one and the other directions at the one ends thereof and to emit the lights in the same wavelength range from the other ends thereof in the one and the other directions;
2N rod integrators having a rectangular parallelepipedic shape, having N rod integrators vertically arranged and N rod integrators transversely arranged at specified spacings with longitudinal side surfaces thereof opposed to each other, receiving the lights emitted from the other ends of the N pairs of the second light guides out of the 4N second light guides in the one direction at one ends of the N vertically arranged rod integrators and emitting the lights in the one direction from the other ends thereof receiving the lights emitted from the other ends of the N pairs of the second light guides in the other direction at one ends of the N transversely arranged rod integrators and emitting the lights in the other direction from the other ends thereof; and
a prism for transmitting the lights emitted from the other ends of the N vertically arranged rod integrators and reflecting the lights emitted from the other ends of the N transversely arranged rod integrators to orient the lights toward the lighting optical system, and
the 2N rod integrators are arranged adjacent to each other in a same plane without defining any clearance therebetween when viewed from a light emergent side of the prism.

31. A display apparatus, comprising:
a lighting apparatus according to claim 20;
a spatial light modulation element for receiving and modulating illumination lights from the lighting apparatus; and
a control circuit for transmitting image color signals corresponding to wavelength ranges to the spatial light modulation element in correspondence with light irradiation regions of the spatial light modulation element in the respective wavelength ranges.

32. A display apparatus, comprising:
a lighting apparatus according to claim 27,
a spatial light modulation element for receiving and modulating illumination lights from the lighting apparatus; and
a control circuit for transmitting image color signals corresponding to wavelength ranges to the spatial light modulation element in correspondence with light irradiation regions of the spatial light modulation element in the respective wavelength ranges.

33. A display apparatus according to claim 32, wherein:
areas of the irradiation regions for the lights in the respective wavelength ranges are set larger than those of the separation regions;
the control circuit controls the spatial light modulation element such that the lights are blocked in near boundary regions of the irradiation regions for the lights in the respective wavelength ranges; and
the near boundary regions are set to cross over the separation regions.

34. A display apparatus according to claim 31, wherein the spatial light modulation element is a micromirror device or a reflective liquid crystal panel.

35. A projection display apparatus, comprising:
a display apparatus according to claim 31; and
a projection optical system for projecting a light modulated by the spatial light modulation element onto a screen.

36. A lighting method, comprising the steps of:
emitting lights in at least three different wavelength ranges; and
dividing the emitted lights into spatially different irradiation regions separated by separation regions for the respective wavelength ranges and successively switching to the different irradiation regions at specified time intervals.

37. An image display method, comprising:
the steps in a lighting method according to claim 36; and
the step of spatially modulating the illumination lights in the respective wavelength ranges in accordance with image color signals corresponding to the wavelength ranges.

38. An image projection method, comprising:
the steps in an image display method according to claim 37; and
the step of projecting the spatially modulated lights onto a screen.
